(19) United States
(12) Patent Application Publication
(10) Pub. No.: US 2026/0024097 A1
(43) Pub. Date: Jan. 22, 2026

(54) EVALUATION METHOD AND DETERMINATION METHOD OF LOW-CARBON TECHNOLOGY, AND ELECTRONIC DEVICE

(71) Applicant: JIANGSU XCMG CONSTRUCTION MACHINERY RESEARCH INSTITUTE LTD., Xuzhou (CN)

(72) Inventors: Xiujie XU, Xuzhou (CN); Guangcun WANG, Xuzhou (CN); Pengfei CHEN, Xuzhou (CN)

(21) Appl. No.: 19/178,279

(22) Filed: Apr. 14, 2025

(30) Foreign Application Priority Data
Jun. 27, 2024 (CN) 202410855202.8

(51) Int. Cl. G06Q 30/018

(52) U.S. Cl. CPC G06Q 30/018

(57) ABSTRACT

The present disclosure provides an evaluation method and determination method of low-carbon technology and an electronic device. The evaluation method includes: determining a first score of the low-carbon technology according to an analytic hierarchy process; determining a second score of the low-carbon technology according to the first score and an energy structure proportion of an industrial entity, wherein the energy structure proportion is a ratio of a consumption of a first type of energy of the industrial entity in a first time period to a consumption of a plurality of types of energy of the industrial entity in the first time period, and the first type is a type of energy saved by using the low-carbon technology; and evaluating an effect of the industrial entity in using the low-carbon technology according to the second score.

### CROSS-REFERENCE TO RELATED APPLICATIONS

The present disclosure is based on and claims priority to China Patent Application No. 202410855202.8 filed on Jun. 27, 2024, the disclosure of which is incorporated by reference herein in its entirety.

### TECHNICAL FIELD

The present disclosure relates to an evaluation method and determination method of a low-carbon technology, and an electronic device.

### BACKGROUND

With the development of society, “saving energy and reducing carbon emissions” has become common sense of the whole society. A low-carbon technology, that is, a technology to reduce carbon emissions, is an important way to achieve this common sense.

### SUMMARY

According to one aspect of embodiments of the present disclosure, an evaluation method of a low-carbon technology is provided. The evaluation method comprises: determining a first score of the low-carbon technology according to an analytic hierarchy process; determining a second score of the low-carbon technology according to the first score and an energy structure proportion of an industrial entity, wherein the energy structure proportion is a ratio of a consumption of a first type of energy of the industrial entity in a first time period to a consumption of a plurality of types of energy of the industrial entity in the first time period, and the first type is a type of energy saved by using the low-carbon technology; and evaluating an effect of the industrial entity in using the low-carbon technology according to the second score.

In some embodiments, the evaluating an effect of the industrial entity in using the low-carbon technology according to the second score comprises: determining a third score of the low-carbon technology according to the second score and a process energy consumption proportion of the industrial entity, wherein the process energy consumption proportion is a ratio of a consumption of energy consumed by a second type of process of the industrial entity in the first time period to a consumption of energy consumed by a plurality of types of processes of the industrial entity in the first time period, and the energy consumed by the second type of process includes the first type of energy; and evaluating the effect of the industrial entity in using the low-carbon technology according to the third score.

In some embodiments, the determining a first score of the low-carbon technology according to an analytic hierarchy process comprises: analyzing a plurality of data required by the analytic hierarchy process to establish an evaluation indicator system, wherein the evaluation indicator system includes a plurality of evaluation indicators including a plurality of first-level indicators and a plurality of second-level indicators, the plurality of second-level indicators is in one-to-one correspondence with the plurality of data, each first-level indicator corresponds to at least one second-level indicator, and each second-level indicator corresponds to only one first-level indicator; calculating a weight of each evaluation indicator in the evaluation indicator system; and determining the first score according to the weight of each evaluation indicator and a membership degree of the plurality of second-level indicators.

In some embodiments, the plurality of data includes one or more of an energy consumption intensity, a carbon emission intensity, an investment cost and a technical safety, wherein: the energy consumption intensity represents a ratio of a consumption of a plurality of types of energy in a case where the industrial entity uses the low-carbon technology in the second time period to a total industrial output value of the industrial entity in the second time period; the carbon emission intensity represents a ratio of a carbon emission in the case where the industrial entity uses the low-carbon technology in the second time period to the total industrial output value; the investment cost represents a cost of using the low-carbon technology by the industrial entity; and the technical safety represents a safety of using the low-carbon technology by the industrial entity.

In some embodiments, the plurality of data further includes one or more of an energy saving amount, a carbon reduction amount, a net income, a technical maturity, and a technical applicability, wherein: the energy saving amount represents a difference between a consumption of a plurality of types of energy in a case where the industrial entity does not use the low-carbon technology in a third time period and the consumption of a plurality of types of energy in the case where the industrial entity uses the low-carbon technology in the second time period, wherein a duration of the third time period is the same as that of the second time period; the carbon reduction amount represents a difference between a carbon emission in the case where the industrial entity does not use the low-carbon technology in the third time period and a carbon emission in the case where the industrial entity uses the low-carbon technology in the second time period; the net income represents a difference between an income in the case where the industrial entity uses the low-carbon technology and the investment cost; the technical maturity represents a practical degree of industrialization of the low-carbon technology; and the technical applicability represents a feasibility of the low-carbon technology in practical application and an effectiveness of the low-carbon technology in practical application.

In some embodiments, the plurality of first-level indicators includes an energy environment indicator, a cost-effectiveness indicator and a technical feature indicator; the energy environment indicator corresponds to the energy consumption intensity, the carbon emission intensity, the energy saving amount and the carbon reduction amount; the cost-effectiveness indicator corresponds to investment cost and the net income; and the technical feature indicator corresponds to the technical safety, the technical maturity and the technical applicability.

In some embodiments, the second score is positively correlated with the first score, and positively correlated with the energy structure proportion.

In some embodiments, the second score is a product of the first score and the energy structure proportion.

In some embodiments, the third score is positively correlated with the second score, and positively correlated with the process energy consumption proportion.

In some embodiments, the third score is a product of the second score and the process energy consumption.

According to another aspect of embodiments of the present disclosure, a determination method of a low-carbon technology is provided. The determination method comprises: determining effects of a plurality of low-carbon technologies to be selected, by using the evaluation method of a low-carbon technology according to any of the above-described embodiments, taking each of the plurality of low-carbon technologies to be selected as the low-carbon technology respectively; and selecting a low-carbon technology to be selected with a best effect from the plurality of low-carbon technologies to be selected as a target low-carbon technology used by the industrial entity.

According to still another aspect of embodiments of the present disclosure, an electronic device is provided. The electronic device comprises: a memory; and a processor coupled to the memory and, based on instructions stored in the memory, configured to determine a first score of the low-carbon technology according to an analytic hierarchy process; determine a second score of the low-carbon technology according to the first score and an energy structure proportion of an industrial entity, wherein the energy structure proportion is a ratio of a consumption of a first type of energy of the industrial entity in a first time period to a consumption of a plurality of types of energy of the industrial entity in the first time period, and the first type is a type of energy saved by using the low-carbon technology; and evaluate an effect of the industrial entity in using the low-carbon technology according to the second score.

In some embodiments, the processor is configured to: determine a third score of the low-carbon technology according to the second score and a process energy consumption proportion of the industrial entity, wherein the process energy consumption proportion is a ratio of a consumption of energy consumed by a second type of process of the industrial entity in the first time period to a consumption of energy consumed by a plurality of types of processes of the industrial entity in the first time period, and the energy consumed by the second type of process includes the first type of energy; and evaluate the effect of the industrial entity in using the low-carbon technology according to the third score.

In some embodiments, the processor is configured to: analyze a plurality of data required by the analytic hierarchy process to establish an evaluation indicator system, wherein the evaluation indicator system includes a plurality of evaluation indicators including a plurality of first-level indicators and a plurality of second-level indicators, the plurality of second-level indicators is in one-to-one correspondence with the plurality of data, each first-level indicator corresponds to at least one second-level indicator, and each second-level indicator corresponds to only one first-level indicator; calculate a weight of each evaluation indicator in the evaluation indicator system; and determine the first score according to the weight of each evaluation indicator and a membership degree of the plurality of second-level indicators.

In some embodiments, the plurality of data includes one or more of an energy consumption intensity, a carbon emission intensity, an investment cost and a technical safety, wherein: the energy consumption intensity represents a ratio of a consumption of a plurality of types of energy in a case where the industrial entity uses the low-carbon technology in the second time period to a total industrial output value of the industrial entity in the second time period; the carbon emission intensity represents a ratio of a carbon emission in the case where the industrial entity uses the low-carbon technology in the second time period to the total industrial output value; the investment cost represents a cost of using the low-carbon technology by the industrial entity; and the technical safety represents a safety of using the low-carbon technology by the industrial entity.

In some embodiments, the plurality of data further includes one or more of an energy saving amount, a carbon reduction amount, a net income, a technical maturity, and a technical applicability, wherein: the energy saving amount represents a difference between a consumption of a plurality of types of energy in a case where the industrial entity does not use the low-carbon technology in a third time period and the consumption of a plurality of types of energy in the case where the industrial entity uses the low-carbon technology in the second time period, wherein a duration of the third time period is the same as that of the second time period; the carbon reduction amount represents a difference between a carbon emission in the case where the industrial entity does not use the low-carbon technology in the third time period and a carbon emission in the case where the industrial entity uses the low-carbon technology in the second time period; the net income represents a difference between an income in the case where the industrial entity uses the low-carbon technology and the investment cost; the technical maturity represents a practical degree of industrialization of the low-carbon technology; and the technical applicability represents a feasibility of the low-carbon technology in practical application and an effectiveness of the low-carbon technology in practical application.

In some embodiments, the plurality of first-level indicators includes an energy environment indicator, a cost-effectiveness indicator and a technical feature indicator; the energy environment indicator corresponds to the energy consumption intensity, the carbon emission intensity, the energy saving amount and the carbon reduction amount; the cost-effectiveness indicator corresponds to investment cost and the net income; and the technical feature indicator corresponds to the technical safety, the technical maturity and the technical applicability.

In some embodiments, the second score is positively correlated with the first score, and positively correlated with the energy structure proportion; and/or the third score is positively correlated with the second score, and positively correlated with the process energy consumption proportion.

In some embodiments, the processor is further configured to determine effects of a plurality of low-carbon technologies to be selected, by taking each of the plurality of low-carbon technologies to be selected as the low-carbon technology respectively; and select a low-carbon technology to be selected with a best effect from the plurality of low-carbon technologies to be selected as a target low-carbon technology used by the industrial entity.

According to still another aspect of embodiments of the present disclosure, a non-transitory computer-readable storage medium is provided. The non-transitory computer-readable storage medium comprises a computer program which, when executed by a processor, implements the evaluation method according to any of the above-described embodiments.

The technical solutions of the present disclosure will be further described in detail below by way of the accompanying drawings and embodiments.

### BRIEF DESCRIPTION OF THE DRAWINGS

To explain the embodiments of the present disclosure or the technical solutions in the related art more explicitly, the accompanying drawings required to be used in the description of the embodiments or the related art will be briefly introduced below. It is apparent that, the accompanying drawings illustrated below are merely some of the embodiments of the present disclosure. For those of ordinary skill in the art, other accompanying drawings may also be obtained according to these accompanying drawings on the premise that no inventive effort is involved.

FIG. 1 is a flowchart of an evaluation method of a low-carbon technology according to some embodiments of the present disclosure.

FIG. 2 is a structural schematic view of an evaluation apparatus of a low-carbon technology according to some embodiments of the present disclosure.

FIG. 3 is a structural schematic view of an electronic device according to some embodiments of the present disclosure.

### DETAILED DESCRIPTION

The technical solutions in the embodiments of the present disclosure will be explicitly and completely described below in conjunction with the accompanying drawings in the embodiments of the present disclosure. Apparently, the embodiments described are merely some of the embodiments of the present disclosure, rather than all of the embodiments. On the basis of the embodiments of the present disclosure, all the other embodiments obtained by those of ordinary skill in the art on the premise that no inventive effort is involved shall fall into the protection scope of the present disclosure.

Unless otherwise specified, the relative arrangements of the components and steps, numerical expressions, and numerical values expounded in these embodiments shall not limit the scope of the present disclosure.

At the same time, it should be understood that, for ease of description, the dimensions of various parts shown in the accompanying drawings are not necessarily drawn according to actual proportional relations.

Techniques, methods, and apparatus known to those of ordinary skill in the relevant art may not be discussed in detail, but where appropriate, these techniques, methods, and apparatuses should be considered as part of this specification.

Among all the examples shown and discussed here, any specific value shall be construed as being merely exemplary, rather than as being restrictive. Thus, other examples in the exemplary embodiments may have different values.

It is to be noted that: similar numerals and letters present similar items in the following accompanying drawings, and therefore, once an item is defined in one accompanying drawing, it does not need to be further discussed in the subsequent accompanying drawings.

In addition, in the description of the present disclosure, the terms such as “first”, “second”, and “third” are used for descriptive purposes only, and cannot be understood to indicate or imply relative importance and sequence. Similarly, although operations are depicted in a particular order in the accompanying drawings, this should not be understood as requiring that such operations be performed in the particular order shown, or that all the illustrated operations be performed to achieve a desired result. In some cases, multitasking processing and parallel processing may be advantageous.

In the related art, an appropriate low-carbon technology cannot be determined for an industrial entity.

It has been found through analysis that, different industrial entities have different actual conditions. However, actual conditions of different industrial entities have not been considered in the related art, resulting in that the effect of a low-carbon technology for a certain energy on the industrial entity cannot be accurately evaluated, and thus an appropriate low-carbon technology for the industrial entity cannot be determined.

To solve the above-described problem, the embodiments of the present disclosure provide the following solutions.

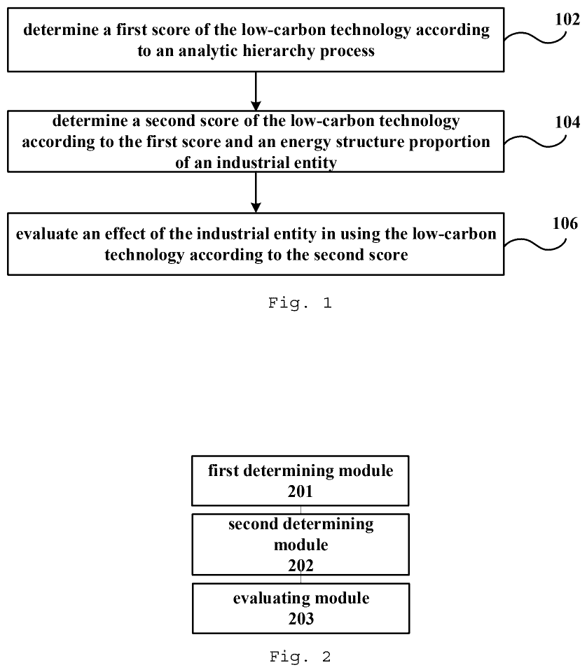

FIG. 1 is a flowchart of an evaluation method of a low-carbon technology according to some embodiments of the present disclosure. It should be understood that, a low-carbon technology is a certain technology that can reduce carbon emissions after being applied, such as dry cutting technology, ultra-high-speed cutting technology, non-preheating welding technology or cold spraying technology.

In step 102, a first score of a low-carbon technology is determined according to an analytic hierarchy process.

In some embodiments, the low-carbon technology may be applied to an industrial entity of a mechanical manufacturing type.

Implementations of the analytic hierarchy process and a calculation method of the first score will be introduced later in conjunction with some embodiments.

In step 104, a second score of the low-carbon technology is determined according to the first score and an energy structure proportion of the industrial entity.

Here, the energy structure proportion is a ratio of a consumption of a first type of energy of the industrial entity in a first time period to a consumption of a plurality of types of energy of the industrial entity in the first time period. The first type is a type of energy saved by using the low-carbon technology.

It should be understood that, the plurality of types of energy includes the first type of energy.

For example, if a plurality of types of energy of a certain industrial entity are type A energy, type B energy and type C energy, and a type of energy saved by using a low-carbon technology is type A, then an energy structure ratio of this certain industrial entity is a ratio of a consumption of type A energy in a first time period to a total consumption of type A energy, type B energy and type C energy of this certain industrial entity in the first time period.

In some embodiments, the first time period may be a month, a quarter or a year. It should be understood that, the first time period may also be set according to actual conditions.

The following sections will introduce how to determine the second score in conjunction with some embodiments.

In step 106, an effect of the industrial entity in using the low-carbon technology is evaluated according to the second score.

In some embodiments, the higher the second score is, the better the effect of the industrial entity in using the low-carbon technology will be.

In the above-described embodiments, after the first score of the low-carbon technology is determined by the analytic hierarchy process, the second score of the low-carbon technology is determined according to the first score and the energy structure proportion of the industrial entity, and then the effect of the industrial entity in using the low-carbon technology is evaluated according to the second score. In this way, the energy structure proportion of the industrial entity is considered, and thus the effect of the low-carbon technology for a certain energy on the industrial entity can be accurately evaluated, which is helpful to determine an appropriate low-carbon technology for the industrial entity.

In some embodiments, the second score of the low-carbon technology is positively correlated with the first score of the low-carbon technology, and positively correlated with the energy structure proportion of the industrial entity.

In other words, in a case where the energy structure proportion is constant, the higher the first score is, the higher the second score will be; in a case where the first score is constant, the higher the energy structure proportion is, the higher the second score will be.

In this way, the second score is positively correlated with the first score, and positively correlated with the energy structure proportion, which may make the second score tend to be the same as a changing direction of the first score and a changing direction of the energy structure proportion, so that the second score can accurately represent the influence of the first score and the energy structure proportion on the effect of the low-carbon technology, which is helpful to determine a more appropriate low-carbon technology for the industrial entity.

In some embodiments, the second score of the low-carbon technology is a product of the first score of the low-carbon technology and the energy structure proportion of the industrial entity.

In this way, the second score is a product of the first score and the energy structure proportion, which may make the second score more tend to be the same as the changing direction of the first score and the changing direction of the energy structure proportion, so that the second score can more accurately represent the influence of the first score and the energy structure proportion on the effect of the low-carbon technology, which is helpful to determine a further more appropriate low-carbon technology for the industrial entity.

In some embodiments, the consumption of the first type of energy of the industrial entity in the first time period (hereinafter referred to as A consumption) may be converted into a consumption of standard coal corresponding to the first type of energy (hereinafter referred to as B consumption), and the consumption of the plurality of types of energy of the industrial entity in the first time period may be converted into a consumption of standard coal corresponding to the plurality of types of energy (hereinafter referred to as C consumption).

For example, the A consumption may be multiplied by the standard coal conversion coefficient of the first type of energy to obtain the B consumption.

For another example, a sum of a consumption of standard coal corresponding to each energy of the plurality of types of energy may be taken as the C consumption.

In this way, by converting the consumption of different types of energy into the consumption of standard coal, an accurate energy structure proportion of the industrial entity under a same scale can be calculated, which is helpful to determine a more appropriate low-carbon technology for the industrial entity.

In some embodiments, a third score of the low-carbon technology is determined according to the second score and a process energy consumption proportion of the industrial entity, and the effect of the industrial entity in using the low-carbon technology is evaluated according to the third score. For example, the higher the third score is, the better the effect of the industrial entity in using the low-carbon technology will be.

Here, the process energy consumption proportion is a ratio of a consumption of energy consumed by a second type of process of the industrial entity in the first time period to a consumption of energy consumed by a plurality of types of processes of the industrial entity in the first time period, and the energy consumed by the second type of process includes the first type of energy.

It should be understood that, the plurality of types of processes includes the second type of process.

As some implementations, the energy consumed by the second type of process is the first type of energy.

For example, a plurality of types of energy of a certain industrial entity are type A energy, type B energy and type C energy, and a type of energy saved by using the low-carbon technology is type A. A plurality of types of processes of this certain industrial entity are type D process, type E process and type F process, and the energy consumed by type D process is type A energy.

In this case, the process energy consumption proportion of this certain industrial entity is a ratio of a consumption of type A energy consumed by type D process in the first time period to a total consumption of energy consumed by type D process, type E process and type F process of the industrial entity in the first time period.

As other implementations, the energy consumed by the second type of process includes at least two types of energy of the plurality of types of energy, wherein the at least two types of energy include the first type of energy.

For example, a plurality of types of energy of a certain industrial entity are type A energy, type B energy and type C energy, and a type of energy saved by using a low-carbon technology is type A. A plurality of types of processes of this certain industrial entity are type D process, type E process and type F process, and energy consumed by type D process is type A energy and type B energy.

In this case, a process energy consumption proportion of this certain industrial entity is a ratio of a consumption of type A energy and type B energy consumed by type D process in the first time period to a total consumption of energy consumed by type D process, type E process and type F process of this certain industrial entity in the first time period.

In this way, the third score of the low-carbon technology is determined according to the second score and a process energy consumption proportion of the industrial entity, and then the effect of the industrial entity in using the low-carbon technology is evaluated according to the third score. On the basis of considering the energy structure proportion, the process energy consumption is further considered, so that the effect of the low-carbon technology for a certain energy on a certain process of the industrial entity can be more accurately evaluated, which is helpful to determine a more appropriate low-carbon technology for the industrial entity.

In some embodiments, the third score of the low-carbon technology is positively correlated with the second score of the low-carbon technology, and positively correlated with the process energy consumption proportion of the industrial entity.

In other words, in a case where the process energy consumption proportion is constant, the higher the second score is, the higher the third score will be; and in a case where the second score is constant, the higher the process energy consumption proportion is, the higher the third score will be.

In this way, the third score is positively correlated with the second score and the process energy consumption proportion, which may make the third score tend to be the same as a changing direction of the second score and a changing direction of the process energy consumption proportion, so that the third score can accurately represent the influence of the second score and the process energy consumption proportion on the effect of the low-carbon technology, which is helpful to determine a more appropriate low-carbon technology for the industrial entity.

In some embodiments, the third score of the low-carbon technology is a product of the second score of the low-carbon technology and the process energy consumption proportion of the industrial entity.

In this way, the third score is a product of the second score and the process energy consumption proportion, which may make the third score more tend to be the same as a changing direction of the second score and a changing direction of the process energy consumption proportion, so that the third score can more accurately represent the influence of the second score and the process energy consumption proportion on the effect of the low-carbon technology, which is helpful to determine a further more appropriate low-carbon technology for the industrial entity.

In some embodiments, the consumption of the energy consumed by the second type of process of the industrial entity in the first time period (hereinafter referred to as D consumption) may be converted into a consumption of standard coal corresponding to the second type of process (hereinafter referred to as E consumption), and the consumption of energy consumed by a plurality of types of processes of the industrial entity in the first time period may be converted into a consumption of standard coal corresponding to the plurality of types of processes (hereinafter referred to as F consumption).

For example, in a case where the energy consumed by the second type of process is the first type of energy, the D consumption may be multiplied by a standard coal conversion coefficient of the first type of energy to obtain the E consumption.

For another example, in a case where the energy consumed by the second type of process includes other types of energy than the first type of energy, a consumption of each energy consumed by the second type of process in the first time period may be multiplied by a standard coal conversion coefficient of this type of energy to obtain a consumption of standard coal corresponding to each energy in the second type of process. A sum of the consumption of standard coal corresponding to each energy in the second type of process is taken as the E consumption.

For another example, a sum of a consumption of standard coal corresponding to each process in a plurality of types of processes may be taken as the F consumption.

In this way, by converting a consumption of the energy consumed by different processes into a consumption of standard coal, an accurate process energy consumption proportion of the industrial entity under a same scale can be calculated, which is helpful to determine a more appropriate low-carbon technology for the industrial entity.

In some embodiments, a plurality of data required by the analytic hierarchy process are analyzed to establish an evaluation indicator system; a weight of each evaluation indicator in the evaluation indicator system is calculated; and the first score of the industrial entity is determined according to the weight of each evaluation indicator and a membership degree of a plurality of second-level indicators.

Here, the evaluation indicator system includes a plurality of evaluation indicators including a plurality of first-level indicators and the plurality of second-level indicators. The plurality of second-level indicators is in one-to-one correspondence with the plurality of data. Each first-level indicator corresponds to at least one second-level indicator, and each second-level indicator corresponds to only one first-level indicator.

Next, the evaluation indicator system, a definition of the weight of each evaluation indicator and a definition of the membership degree of the second-level indicator will be introduced in conjunction with Table 1.

As some implementations, as shown in Table 1, the evaluation indicator system includes a target layer, a criterion layer and an indicator layer.

For example, as shown in Table 1, a plurality of data required by the analytic hierarchy process are T1, T2, T3 and T4; the target layer represents a target of the analytic hierarchy process, that is, evaluating the effect of the industrial entity in using the low-carbon technology; the criterion layer includes the plurality of first-level indicators (F1, F2 and F3) among the plurality of evaluation indicators; and the indicator layer includes the plurality of second-level indicators (S1, S2, S3 and S4) among the plurality of evaluation indicators. S1 corresponds to T1, and so forth; and F1 corresponds to S1 and S2, and so forth.

TABLE 1

| Target layer | Criterion layer | Indicator layer |
|---|---|---|
| Evaluate the | F1 | S1 (T1) |
| effect of the | | S2 (T2) |
| low-carbon | F2 | S3 (T3) |
| technology | F3 | S4 (T4) |

The weight of a first-level indicator represents an importance degree of the first-level indicator in the criterion layer. For example, as shown in Table 1, the weight of F1 represents the importance degree of F1 in the criteria layer.

The weight of a second-level indicator represents the importance degree of the second-level indicator in the indicator layer of a first-level indicator corresponding to the second-level indicator. For example, as shown in Table 1, the weight of S1 represents the importance degree of S1 in the indicator layer of F1 corresponding to S1.

The following sections will introduce how to determine the weight of the evaluation indicator in conjunction with some embodiments.

Since contents of a plurality of data required by the analytic hierarchy process are different, it is necessary to quantify the contents of the plurality of data under a same scale and represent the quantized results. The membership degree of a second-level indicator may represent a result of quantifying the data corresponding to the second-level indicator.

For example, as shown in Table 1, the membership degree of S1 represents a result of quantifying T1. The following sections will introduce how to determine the membership degree of a second-level indicator in conjunction with some embodiments.

In this way, by establishing an evaluation indicator system including a plurality of evaluation indicators, calculating the weight of each evaluation indicator in the evaluation indicator system, and further determining the first score of the low-carbon technology according to the weight of each evaluation indicator and the membership degree of a plurality of second-level indicators, the first score of the low-carbon technology is accurately obtained and thus an accurate second score is obtained, which is helpful to determine a more appropriate low-carbon technology for the industrial entity.

Next, the following sections will introduce how to determine the weight of each evaluation indicator in conjunction with Tables 2 to 5.

In some embodiments, the weight of each evaluation indicator is a corresponding element in a characteristic vector of a judgment matrix. Here, for the first-level indicator, there is a judgment matrix of the first-level indicator; and for the second-level indicator, there is a judgment matrix of the second-level indicator. Weights of all first-level indicators constitute a single-factor weight set R1 of first-level indicator, and weights of all second-level indicators constitute a single-factor weight set R2 of second-level indicator.

The judgment matrix of the first-level indicator and the judgment matrix of the second-level indicator may both be represented as:

$$P = {( {a}_{ij} )}_{n * n} [ \begin{matrix}{a}_{11} & ⋯ & {a}_{1 n} \\ ⋯ & ⋱ & ⋯ \\ {a}_{n 1} & ⋯ & {a}_{nn}\end{matrix} ]$$

Here, for the first-level indicator, i is a natural number greater than 0 and less than or equal to the number n of the first-level indicators, and j is a natural number greater than 0 and less than or equal to n.

For the second-level indicator, i is a natural number greater than 0 and less than or equal to the number n of the second-level indicators, and j is a natural number greater than 0 and less than or equal to n.

For the first-level indicator, aᵢⱼ represents a quantitative scale value of an importance degree of first-level indicator i relative to first-level indicator j; and for the second-level indicator, aᵢⱼ represents a quantitative scale value of an importance degree of second-level indicator i relative to second-level indicator j.

The valuing rule of aᵢⱼ (i.e., a rule of a quantitative scale) is shown in Table 2, and indicator i and indicator j in Table 2 are indicators of the same level. That is, indicator i and indicator j are both first-level indicators, or indicator i and indicator j are both second-level indicators.

TABLE 2

| Meaning | aᵢⱼ |
|---|---|
| Indicator i is equally important | 1 |
| relative to indicator j | |
| Indicator i is slightly more | 3 |
| important than indicator j | |
| Indicator i is moderately more | 5 |
| important than indicator j | |
| Indicator i is strongly more | 7 |
| important than indicator j | |
| Indicator i is extremely more | 9 |
| important than indicator j | |
| Medium values of two adjacent | 2, 4, 6, 8 |
| judgments | |
| Importance degree of indicator j | aᵢⱼ = 1/aᵢⱼ |
| relative to indicator i is | |
| represented by reciprocal | |

Here, in a case where indicator i is equally important relative to indicator j, aᵢⱼ is 1; in a case where indicator i is slightly more important than indicator j, aᵢⱼ is 3; in a case where indicator i is moderately more important than indicator j, aᵢⱼ is 5; in a case where indicator i is strongly more important than indicator j, aᵢⱼ is 7; in a case where indicator i is extremely more important than indicator j, aᵢⱼ is 9.

In a case where indicator i is between equally important and slightly more important relative to the indicator j, aᵢⱼ may be 2; in a case where indicator i is between slightly more important and moderately more important relative to indicator j, aᵢⱼ may be 4; in a case where indicator i is between moderately more important and strongly more important relative to indicator j, aᵢⱼ may be 6; in a case where indicator i is between strongly more important and extremely more important than indicator j, aᵢⱼ may be 8.

It should be understood that, the importance degree of indicator i relative to indicator j may be determined by expert review, and also be determined by other methods, which is not limited here.

In this case, as shown in Table 3, a quantitative scale table may be established for the criterion layer. That is, a quantitative scale table is established for the first-level indicator.

TABLE 3

| | F1 | F2 | F3 |
|---|---|---|---|
| F1 | 1 | a | b |
| F2 | 1/a | 1 | c |
| F3 | 1/b | 1/c | 1 |

Here, a represents an importance degree of F2 compared with F1, b represents an importance degree of F3 compared with F1, and c represents an importance degree of F3 compared with F2. For example, for values of a, b and c, reference may be made to Table 2.

In this case, a judgment matrix P may be established through the quantitative scale table. The judgment matrix

$$P = [ \begin{matrix}1 & a & b \\ 1 / a & 1 & c \\ 1 / b & 1 / c & 1\end{matrix} ] ,$$

and a characteristic vector of judgment matrix P may be represented as [e, f, g]^{T}, for example. Here, the weight of F1 is e, the weight of F2 is f, and the weight of F3 is g.

A quantitative scale table may be established for an indicator layer corresponding to each criterion layer. That is, a quantitative scale table is established for the second-level indicator.

For example, Table 4 shows a quantitative scale table of an indicator layer corresponding to F1.

TABLE 4

| | S1 | S2 |
|---|---|---|
| S1 | 1 | h |
| S2 | 1/h | 1 |

Here, h represents an importance degree of S2 compared with S1. For example, for a value of h, reference may be made to Table 2.

In this case, judgment matrix P may be established by the quantitative scale table. the judgement matrix

$$P = [ \begin{matrix}1 & h \\ 1 / h & 1\end{matrix} ] ,$$

and a characteristic vector of judgement matrix P may be represented as [m, n]^{T}, for example. Here, the weight of S1 is m, and the weight of S2 is n.

It should be understood that, in a case where there is only one second-level indicator in an indicator layer corresponding to a criterion layer, the weight of the second-level indicator is 1.

In this way, by constructing a judgment matrix related to the importance degree of evaluation indicators, and determining the weights of the evaluation indicators through a characteristic vector of the judgment matrix, the weight of each evaluation indicator can be accurately determined, and then the first score of a low-carbon technology can be more accurately determined, thereby obtaining a more accurate second score, which is helpful to determine a more appropriate low-carbon technology for an industrial entity.

In some embodiments, a consistency test may be performed on a judgment matrix, and the weight of each evaluation indicator is a corresponding element in a characteristic vector of the judgment matrix that passes the consistency test.

As some implementations, in a case where a consistency ratio (CR) of the judgment matrix is less than 0.1, it is determined that the judgment matrix passes the consistency test; in a case where CR of the judgment matrix is greater than or equal to 0.1, it is determined that the judgment matrix fails to pass the consistency test.

Here, CR=CI/RI. CI represents a consistency indicator of the judgment matrix, and RI represents an average random consistency indicator of the judgment matrix.

In this way, a consistency test on a judgment matrix is helpful to accurately determine the weight of each evaluation indicator, thereby further accurately determining the first score of a low-carbon technology so as to further accurately obtain the second score, which is helpful to determine a further more appropriate low-carbon technology for an industrial entity.

Next, how to determine the first score of a low-carbon technology according to the weight of each evaluation indicator and the membership degree of a plurality of second-level indicators will be introduced in conjunction with Tables 3 to 8.

In some embodiments, a comprehensive factor weight set W of a second-level indicator is determined according to a single factor weight set R1 of first-level indicator and a single factor weight set R2 of second-level indicator; a product of a comprehensive factor weight of each second-level indicator in the comprehensive factor weight set W and the membership degree of this second-level indicator is taken as a score of this second-level indicator; and a sum of scores of all second-level indicators is taken as the first score of the low-carbon technology.

As some implementations, the comprehensive factor weight set W includes a comprehensive factor weight of each second-level indicator, and the comprehensive factor weight of each second-level indicator is a product of the weight of this second-level indicator and the weight of the first-level indicator corresponding to this second-level indicator.

For example, in conjunction with Tables 3 and 4, as shown in Table 5, the comprehensive factor weight set W=[e*m, e*n, f, g].

TABLE 5

| Target | Criterion | | Indicator | | Comprehensive |
|---|---|---|---|---|---|
| layer | layer | Weight | layer | Weight | factor weight |
| Evaluate the | F1 | e | S1 | m | e*m |
| effect of the | | | S2 | n | e*n |
| low-carbon | F2 | f | S3 | 1 | f*1 |
| technology | F3 | g | S4 | 1 | g*1 |

As some implementations, the plurality of second-level indicators includes quantitative indicators. In this case, each quantitative indicator is normalized to obtain the membership degree of each quantitative indicator. Here, the membership degree of the plurality of second-level indicators includes the membership degree of each quantitative indicator.

For example, a membership function of a semi-trapezoidal distribution may be used to normalize a quantitative indicator to determine the membership of the quantitative indicator.

In a case where a quantitative indicator is a positive indicator (i.e., the larger the better), a membership function u_{qk} of an ascending semi-trapezoid distribution may be used for calculation, wherein

$${u}_{qk} = \{ \begin{matrix}1 & {x}_{k} \geq {a}_{2} \\ \frac{{x}_{k} - {a}_{1}}{{a}_{2} - {a}_{1}} & {a}_{1} \leq {x}_{k} \leq {a}_{2} \\ 0 & 0 \leq {x}_{k} \leq {a}_{1}\end{matrix} .$$

In a case where a quantitative indicator is a negative indicator (i.e., the smaller the better), a membership function u_{qk} of a descending semi-trapezoid distribution may be used for calculation, wherein

$${u}_{qk} = \{ \begin{matrix}1 & 0 \leq {x}_{k} \leq {a}_{1} \\ \frac{{a}_{2} - {x}_{k}}{{a}_{2} - {a}_{1}} & {a}_{1} \leq {x}_{k} \leq {a}_{2} \\ 0 & {x}_{k} \geq {a}_{2}\end{matrix} .$$

Here, u_{qk} represents the membership degree of a k-th quantitative indicator of after applying a q-th low-carbon technology; xₖ represents data corresponding to the k-th quantitative indicator of after applying the q-th low-carbon technology; a₁ represents a minimum value of all xₖ; a₂ represents a maximum value of all xₖ, and k and q are both natural numbers greater than 0.

As some implementations, the plurality of second-level indicators includes qualitative indicators. In this case, each qualitative indicator is assigned a value and normalized according to the grade of each qualitative indicator and an assignment correspondence table to obtain the membership degree of each qualitative indicator. Here, the assignment correspondence table includes a correspondence between a grade and a value, and the membership degree of the plurality of second-level indicators includes the membership degree of each qualitative indicator.

For example, Table 6 is an assignment correspondence table. In Table 6, a qualitative indicator with a grade of “better/lower/shorter” may be assigned any value greater than 4 and less than or equal to 5; a qualitative indicator with a grade of “good/low/ short” may be assigned any value greater than 3 and less than or equal to 4; a qualitative indicator with a grade of “medium” may be assigned any value greater than 2 and less than or equal to 3; a qualitative indicator with a grade of “bad/high/long” may be assigned any value greater than 1 and less than or equal to 2; and a qualitative indicators with a grade of “worse/higher/longer” may be assigned any value greater than 0 and less than or equal to 1.

TABLE 6

| | Better/ | | | | Worse/ |
|---|---|---|---|---|---|
| Qualitative | lower/ | Good/ | | Bad/ | higher/ |
| indicator | shorter | low/short | Medium | high/long | longer |
| Valuation | (4, 5] | (3, 4] | (2, 3] | (1, 2] | (0, 1] |

In this case, for example, the membership degree of a qualitative indicator may be determined by a membership degree function of a qualitative indicator.

Here, the membership function u_{qr} of a qualitative indicator is

$${u}_{qr} = \frac{{x}_{r}}{5} .$$

u_{qr} represents the membership degree of a r-th qualitative indicator of after applying a q-th low-carbon technology, xᵣ represents an assigned value corresponding to the r-th qualitative indicator after applying the q-th low-carbon technology, and r is a natural number greater than 0.

It should be understood that, in a case where the plurality of second-level indicators includes a quantitative indicator and a qualitative indicator, a corresponding membership degree needs to be determined for the quantitative indicator and the qualitative indicator respectively.

In conjunction with Table 1, the membership degree of each second-level indicator may be represented by a membership degree matrix L (Table 7), for example.

TABLE 7

| | |
|---|---|
| Second- | Low-carbon Technology |

| level | Low-carbon | Low-carbon | | Low-carbon |
|---|---|---|---|---|
| indicator | technology 1 | technology 2 | . . . | technology q |
| S1 | u₁₁ | u₂₁ | . . . | u_{q1} |
| S2 | u₁₂ | u₂₂ | . . . | u_{q2} |
| S3 | u₁₃ | u₂₃ | . . . | u_{q3} |
| S4 | u₁₄ | u₂₄ | . . . | u_{q4} |

In this case, in conjunction with Tables 5 and 7, as shown in Table 8, the first score of the low-carbon technology q may be obtained.

TABLE 8

| Target | Criterion | | Indicator | | Comprehensive | Indicator |
|---|---|---|---|---|---|---|
| layer | layer | Weight | layer | Weight | factor weight | score |
| Evaluate | F1 | e | S1 | m | e*m | e*m*u_{q1} |
| the effect | | | S2 | n | e*n | e*n*u_{q2} |
| of the | F2 | f | S3 | 1 | f*1 | f*u_{q3} |
| low-carbon | F3 | g | S4 | 1 | g*1 | g*u_{q4} |

| | |
|---|---|
| technology | The first score: e*m*u_{q1} + e*n*u_{q2} + f*u_{q3} + g*u_{q4} |

In the above-described embodiments, the comprehensive factor weight set W is determined according to the single factor weight set R1 and the single factor weight set R2, a product of the comprehensive factor weight of each second-level indicator in the comprehensive factor weight set W and the membership degree of the second-level indicator is taken as the score of this second-level indicator, and a sum of scores of all second-level indicators is taken as the first score of a low-carbon technology, thereby more accurately obtaining the first score of the low-carbon technology to more accurately obtain the second score, which is helpful to determine a further more appropriate low-carbon technology for the industrial entity.

In some embodiments, the plurality of data includes one or more of an energy consumption intensity, a carbon emission intensity, an investment cost and a technical safety.

For example, the plurality of data includes any one of an energy consumption intensity, a carbon emission intensity, an investment cost or a technical safety. For another example, the plurality of data includes any two of an energy consumption intensity, a carbon emission intensity, an investment cost and a technical safety. For still another example, the plurality of data includes any three of an energy consumption intensity, a carbon emission intensity, an investment cost and a technical safety. For yet still another example, the plurality of data includes an energy a consumption intensity, a carbon emission intensity, an investment cost and a technical safety.

Here, the energy consumption intensity represents a ratio of a consumption of a plurality of types of energy in a case where an industrial entity uses a low-carbon technology in a second time period to a total industrial output value of the industrial entity in the second time period. For example, the second time period may be a month, a quarter or a year. It should be understood that, the second time period may also be set according to actual conditions. As some implementations, the second time period and the first time period may be the same time period.

The carbon emission intensity represents a ratio of a carbon emission in a case where the industrial entity uses the low-carbon technology in the second time period to the total industrial output value of the industrial entity in the second time period.

The investment cost represents a cost of using the low-carbon technology by the industrial entity.

The technical safety represents a safety of using the low-carbon technology by the industrial entity.

As some implementations, the investment cost includes an operation-and-maintenance expense generated by using the low-carbon technology in the second time period, and a basic expense of using the low-carbon technology.

As some implementations, the technical safety represents a safety of personnel, device, environment and information in links such as design, application and operation of the low-carbon technology.

In this way, the plurality of data includes one or more of the energy consumption intensity, the carbon emission intensity, the investment cost and the technical safety, and thus an accurate evaluation indicator system can be established, thereby more accurately obtaining the first score of the low-carbon technology to more accurately obtain the second score, which is helpful to determine a further more appropriate low-carbon technology for the industrial entity.

In some embodiments, as shown in Table 9, the plurality of first-level indicators includes an energy environment indicator, a cost-effectiveness indicator and a technical feature indicator. The energy environment indicator corresponds to the energy consumption intensity and the carbon emission intensity, the cost-effectiveness indicator corresponds to the investment cost, and the technical feature indicator corresponds to the technical safety.

TABLE 9

| Target layer | Criterion layer | Indicator layer |
|---|---|---|
| Evaluate the effect | Energy environment | Energy consumption |
| of the low-carbon | (F1) | intensity (S1) |
| technology | | Carbon emission |
| | | intensity (S2) |
| | Cost-effectiveness (F2) | Investment cost (S3) |
| | Technical feature (F3) | Technical safety (S4) |

Here, the energy intensity, the carbon emission intensity and the investment cost are quantitative indicators, and the technical safety is a qualitative indicator. In this case, the first score of the low-carbon technology may be determined in conjunction with Table 8.

In this way, the plurality of first-level indicators includes the energy environment indicator, the cost-effectiveness indicator and the technical feature indicator, wherein the energy environment indicator corresponds to the energy consumption intensity and the carbon emission intensity, the cost-effectiveness indicator corresponds to the investment cost, and the technical feature indicator corresponds to the technical safety, and a more accurate evaluation indicator system may be established, so that it is possible to further more accurately obtain a first score of the low-carbon technology so as to further more accurately obtain a second score, which is helpful to determine a further more appropriate low-carbon technology for the industrial entity.

In some embodiments, the plurality of data further includes one or more of an energy saving amount, a carbon reduction amount, a net income, a technical maturity and a technical applicability.

The energy saving amount represents a difference between a consumption of a plurality of types of energy in a case where the industrial entity does not use a low-carbon technology in the third time period and a consumption of the plurality of types of energy in a case where the industrial entity uses the low-carbon technology in the second time period. Here, the duration of the third time period is the same as that of the second time period.

The carbon reduction amount represents a difference between a carbon emission in a case where the industrial entity does not use a low-carbon technology in the third time period and a carbon emission in a case where the industrial entity uses the low-carbon technology in the second time period.

The net income represents a difference between an income in a case where the industrial entity uses the low-carbon technology and an investment cost. For example, the net income is a net income in the second time period.

The technical maturity represents a practical degree of industrialization of the low-carbon technology.

As some implementations, the technical maturity represents the practical degree of industrialization of the low-carbon technology in terms of technical level, technological process, supporting resources and life cycle, etc.

The technical applicability represents a feasibility of the low-carbon technology in practical application and an effectiveness of the low-carbon technology in practical application.

As some implementations, the feasibility represents a degree to which the low-carbon technology meets a specific need and a degree to which the low-carbon technology is adapted to a specific environment; and the effectiveness represents a degree to which the low-carbon technology achieves an expected effect.

In this way, the plurality of data further includes one or more of an energy saving amount, a carbon reduction amount, a net income, a technical maturity and a technical applicability, and thus a more accurate evaluation indicator system can be established, thereby further more accurately determining the first score of the low-carbon technology to more accurately obtain the second score, which is helpful to determine a further more appropriate low-carbon technology for the industrial entity.

In some embodiments, as shown in Table 10, the energy environment indicator corresponds to the energy consumption intensity, the carbon emission intensity, the energy saving amount and the carbon reduction amount; the cost-effectiveness indicator corresponds to the investment cost and a net income; and the technical feature indicator corresponds to the technical safety, the technical maturity and the technical applicability.

TABLE 10

| Target layer | Criterion layer | Indicator layer |
|---|---|---|
| Evaluate the effect of | Energy environment | Energy consumption |
| the low-carbon | | intensity |
| technology | | Carbon emission |
| | | intensity |
| | | Energy saving amount |
| | | Carbon reduction |
| | | amount |
| | Cost-effectiveness | Investment cost |
| | | Net income |
| | Technical feature | Technical maturity |
| | | Technical applicability |
| | | Technical safety |

Here, the energy intensity, the carbon emission intensity, the energy saving amount, the carbon reduction amount, the investment cost and the net income are quantitative indicators; and the technical maturity, the technical applicability and the technical safety are qualitative indicators. In this case, the first score of the low-carbon technology may be determined in conjunction with Table 8.

In this way, a plurality of first-level indicators includes the energy environment indicator, the cost-effectiveness indicator and the technical feature indicator, wherein the energy environment indicator corresponds to the energy consumption intensity, the carbon emission intensity, the energy saving amount and the carbon reduction amount, the cost-effectiveness indicator corresponds to the investment cost and the net income, and the technical feature indicator corresponds to the technical safety, the technical maturity and the technical applicability, and the more accurate evaluation indicator system may be established, so that it is possible to further more accurately obtain the first score of the low-carbon technology so as to further more accurately obtain the second score, which is helpful for determine a further more appropriate low-carbon technology for the industrial entity.

The present disclosure further provides a determination method of a low-carbon technology, which comprises step S1 and step S2.

In step S1, effects of a plurality of low-carbon technologies to be selected are determined, by using the evaluation method of a low-carbon technology in any of the above-described embodiments, where each of a plurality of low-carbon technologies to be selected is taken as the low-carbon technology in the evaluation method of a low-carbon technology in any of the above-described embodiments respectively.

In step S2, a low-carbon technology to be selected with a best effect is selected from the plurality of low-carbon technologies to be selected as a target low-carbon technology used by the industrial entity.

For example, as shown in Tables 7 and 8, the low-carbon technology 1 to the low-carbon technology q are a plurality of low-carbon technologies to be selected, and a low-carbon technology with the highest third-level score among the low-carbon technology 1 to the low-carbon technology q is taken as the target low-carbon technology used by the industrial entity. That is, the target low-carbon technology is a low-carbon technology appropriate for the industrial entity.

In this way, by using the evaluation method of a low-carbon technology disclosed in the present disclosure, the target low-carbon technology is selected from a plurality of low-carbon technologies to be selected for use by the industrial entity, and thus appropriate low-carbon technologies for different industrial entities can be accurately determined.

Various embodiments in this specification are described in a progressive manner, differences from other embodiments are mainly illustrated in each embodiment, and reference may be made to each other for the same or similar parts between various embodiments. As for the embodiments of apparatus and device, since they substantially correspond to the embodiments of method, the description thereof is relatively simple. For relevant parts, reference may be made to the description of the embodiments of method.

In some embodiments, the evaluation apparatus of a low-carbon technology may comprise modules for performing the evaluation method of a low-carbon technology according to the above-described embodiments.

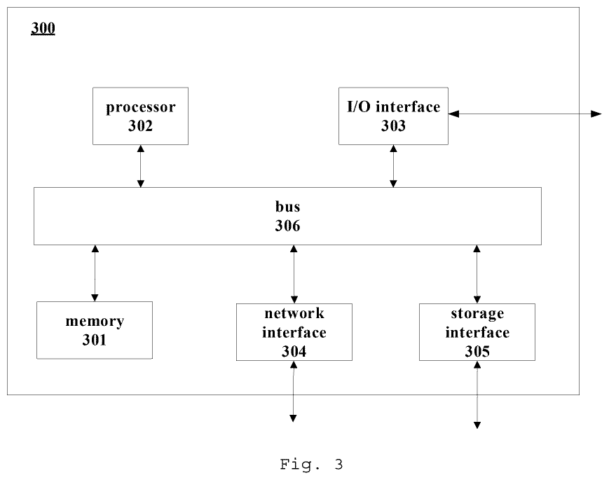

FIG. 2 is a structural schematic view of an evaluation apparatus of a low-carbon technology according to some embodiments of the present disclosure.

As shown in FIG. 2, the evaluation apparatus of a low-carbon technology comprises a first determining module 201, a second determining module 202 and an evaluating module 303.

The first determining module 201 is configured to determine a first score of the low-carbon technology according to an analytic hierarchy process.

The second determining module 202 is configured to determine a second score of the low-carbon technology according to the first score and an energy structure proportion of an industrial entity. Here, the energy structure proportion is a ratio of a consumption of a first type of energy of the industrial entity in a first time period to a consumption of a plurality of types of energy of the industrial entity in the first time period, and the first type is a type of energy saved by using the low-carbon technology.

The evaluating module 203 is configured to evaluate an effect of the industrial entity in using the low-carbon technology according to the second score.

In some embodiments, the evaluating module 203 is configured to determine a third score of the low-carbon technology according to the second score and a process energy consumption proportion of the industrial entity, wherein the process energy consumption proportion is a ratio of a consumption of energy consumed by a second type of process of the industrial entity in the first time period to a consumption of energy consumed by a plurality of types of processes of the industrial entity in the first time period, and the energy consumed by the second type of process includes the first type of energy; and evaluate the effect of the industrial entity in using the low-carbon technology according to the third score.

In some embodiments, the first determining module 201 is configured to analyze a plurality of data required by the analytic hierarchy process to establish an evaluation indicator system, wherein the evaluation indicator system includes a plurality of evaluation indicators including a plurality of first-level indicators and a plurality of second-level indicators, the plurality of second-level indicators is in one-to-one correspondence with the plurality of data, each first-level indicator corresponds to at least one second-level indicator, and each second-level indicator corresponds to only one first-level indicator; calculate a weight of each evaluation indicator in the evaluation indicator system; and determine the first score according to the weight of each evaluation indicator and a membership degree of the plurality of second-level indicators.

In some embodiments, the plurality of data includes one or more of an energy consumption intensity, a carbon emission intensity, an investment cost and a technical safety, wherein: the energy consumption intensity represents a ratio of a consumption of a plurality of types of energy in a case where the industrial entity uses the low-carbon technology in a second time period to a total industrial output value of the industrial entity in the second time period; the carbon emission intensity represents a ratio of a carbon emission in the case where the industrial entity uses the low-carbon technology in the second time period to the total industrial output value; the investment cost represents a cost of using the low-carbon technology by the industrial entity; and the technical safety represents a safety of using the low-carbon technology by the industrial entity.

In some embodiments, the plurality of data further includes one or more of an energy saving amount, a carbon reduction amount, a net income, a technical maturity, and a technical applicability, wherein: the energy saving amount represents a difference between a consumption of a plurality of types of energy in a case where the industrial entity does not use the low-carbon technology in a third time period and the consumption of a plurality of types of energy in the case where the industrial entity uses the low-carbon technology in the second time period, wherein a duration of the third time period is the same as that of the second time period; the carbon reduction amount represents a difference between a carbon emission in the case where the industrial entity does not use the low-carbon technology in the third time period and a carbon emission in the case where the industrial entity uses the low-carbon technology in the second time period; the net income represents a difference between an income in the case where the industrial entity uses the low-carbon technology and the investment cost; the technical maturity represents a practical degree of industrialization of the low-carbon technology; and the technical applicability represents a feasibility of the low-carbon technology in practical application and an effectiveness of the low-carbon technology in practical application.

In some embodiments, the plurality of first-level indicators includes an energy environment indicator, a cost-effectiveness indicator and a technical feature indicator; the energy environment indicator corresponds to the energy consumption intensity, the carbon emission intensity, the energy saving amount and the carbon reduction amount; the cost-effectiveness indicator corresponds to investment cost and the net income; and the technical feature indicator corresponds to the technical safety, the technical maturity and the technical applicability.

In some embodiments, the second score is positively correlated with the first score, and positively correlated with the energy structure proportion.

In some embodiments, the second score is a product of the first score and the energy structure proportion.

In some embodiments, the third score is a product of the second score and the process energy consumption.

In some embodiments, the evaluation apparatus of a low-carbon technology may further comprise other module(s) for performing the evaluation method of a low-carbon technology according to any of the above-described embodiments.

The embodiments of the present disclosure also provide a determination apparatus of a low-carbon technology, which comprises the evaluation apparatus of a low-carbon technology according to any of the above-described embodiments, and a selecting module.

The determination apparatus of a low-carbon technology is configured to determine effects of a plurality of low-carbon technologies to be selected, by taking each of the plurality of low-carbon technologies to be selected as the low-carbon technology in the evaluation apparatus of a low-carbon technology according to any of the above-described embodiments respectively.

The selecting module is configured to select a low-carbon technology to be selected with a best effect from the plurality of low-carbon technologies to be selected as a target low-carbon technology used by the industrial entity.

In some embodiments, the determination apparatus of a low-carbon technology may further comprise other module(s) for performing the determination method of a low-carbon technology according to any of the above-described embodiments.

FIG. 3 is a structural schematic view of an electronic device according to some embodiments of the present disclosure.

As shown in FIG. 3, the electronic device 300 comprises: a memory 301 and a processor 302 coupled to the memory 301. The processor 302 is, based on instructions stored in the memory 301, configured to perform the method according to any of the afore-mentioned embodiments.

The memory 301 may comprise, for example, a system memory, a fixed non-volatile storage medium, and the like. The system memory may store, for example, an operation system, an application program, a boot loader, and other programs.

In some embodiments, the electronic device 300 may further comprise an Input/Output (I/O) interface 303, a network interface 304, a storage interface 305, and the like. The I/O interface 303, the network interface 304 and the storage interface 305, as well as the memory 301 and the processor 302, may be connected, for example, via a bus 306. The I/O interface 303 provides a connection interface for input/output devices such as a display, a mouse, a keyboard, or a touch screen. The network interface 304 provides a connection interface for various networked devices. The storage interface 305 provides a connection interface for an external storage device such as an SD card or a USB flash disk.

The embodiments of the present disclosure further provide a non-transitory computer-readable storage medium comprising computer program instructions that, when executed by a processor, implement the method according to any of the above-described embodiments.

The embodiments of the present disclosure further provide a computer program product comprising a computer program that, when executed by a processor, implements the steps of the method according to any of the above-described embodiments.

Hereto, various embodiments of the present disclosure have been described in detail. Some details well known in the art are not described to avoid obscuring the concept of the present disclosure. According to the above description, those skilled in the art would fully understand how to implement the technical solutions disclosed here.

Those skilled in the art should understand that the embodiments of the present disclosure may be provided as a method, a system, or a computer program product. Accordingly, the present disclosure may take the form of an entirely hardware embodiment, an entirely software embodiment, or a combination of software and hardware aspects. Moreover, the present disclosure may take the form of a computer program product implemented on one or more computer-usable non-transitory storage media (comprising but not limited to a disk memory, a CD-ROM, an optical memory, and the like) with computer usable program codes thereon.

The present disclosure is described with reference to the flowcharts and/or block diagrams of methods, devices (systems), and computer program products according to the embodiments of the present disclosure. It should be understood that: a function specified in one or more processes in the flowcharts and/or one or more blocks in the block diagrams may be implemented by computer program instructions. These computer program instructions may be provided to a processor of a general purpose computer, a special purpose computer, an embedded processing machine, or other programmable data processing devices to produce a machine, such that a device for implementing a function specified in one or more processes of flowcharts and/or one or more blocks in block diagrams is produced by the instructions executed by a processor of a computer or other programmable data processing devices.

These computer program instructions may also be stored in a computer readable memory that can guide a computer or other programmable data processing devices to operate in a particular manner, such that the instructions stored in the computer readable memory produce an article of manufacture comprising an instruction device. The instruction device implements a function specified in one or more processes in flow charts and/or one or more blocks in block diagrams.

These computer program instructions may also be loaded onto a computer or other programmable data processing devices to perform a series of operational steps on the computer or other programmable devices to produce a computer-implemented process, such that the instructions executed on the computer or other programmable devices provide steps for implementing a function specified in one or more processes of the flowcharts and/or one or more blocks in the block diagrams.

Although some specific embodiments of the present disclosure have been described in detail by way of examples, those skilled in the art should understand that the above examples are only for the purpose of illustration but not for limiting the scope of the present disclosure. It should be understood by those skilled in the art that modifications to the above embodiments and equivalently substitution of a part of the technical features can be made without departing from the scope and spirit of the present disclosure. The scope of the present disclosure is defined by the appended claims.

What is claimed is:

1. An evaluation method of a low-carbon technology, comprising:
determining a first score of the low-carbon technology according to an analytic hierarchy process;
determining a second score of the low-carbon technology according to the first score and an energy structure proportion of an industrial entity, wherein the energy structure proportion is a ratio of a consumption of a first type of energy of the industrial entity in a first time period to a consumption of a plurality of types of energy of the industrial entity in the first time period, and the first type is a type of energy saved by using the low-carbon technology; and
evaluating an effect of the industrial entity in using the low-carbon technology according to the second score.

2. The evaluation method according to claim 1, wherein the evaluating an effect of the industrial entity in using the low-carbon technology according to the second score comprises:
determining a third score of the low-carbon technology according to the second score and a process energy consumption proportion of the industrial entity, wherein the process energy consumption proportion is a ratio of a consumption of energy consumed by a second type of process of the industrial entity in the first time period to a consumption of energy consumed by a plurality of types of processes of the industrial entity in the first time period, and the energy consumed by the second type of process includes the first type of energy; and
evaluating the effect of the industrial entity in using the low-carbon technology according to the third score.

3. The evaluation method according to claim 1, wherein the determining a first score of the low-carbon technology according to an analytic hierarchy process comprises:
analyzing a plurality of data required by the analytic hierarchy process to establish an evaluation indicator system, wherein the evaluation indicator system includes a plurality of evaluation indicators including a plurality of first-level indicators and a plurality of second-level indicators, the plurality of second-level indicators is in one-to-one correspondence with the plurality of data, each first-level indicator corresponds to at least one second-level indicator, and each second-level indicator corresponds to only one first-level indicator;
calculating a weight of each evaluation indicator in the evaluation indicator system; and
determining the first score according to the weight of each evaluation indicator and a membership degree of the plurality of second-level indicators.

4. The evaluation method according to claim 3, wherein the plurality of data includes one or more of an energy consumption intensity, a carbon emission intensity, an investment cost and a technical safety, wherein:
the energy consumption intensity represents a ratio of a consumption of a plurality of types of energy in a case where the industrial entity uses the low-carbon technology in a second time period to a total industrial output value of the industrial entity in the second time period;
the carbon emission intensity represents a ratio of a carbon emission in the case where the industrial entity uses the low-carbon technology in the second time period to the total industrial output value;
the investment cost represents a cost of using the low-carbon technology by the industrial entity; and
the technical safety represents a safety of using the low-carbon technology by the industrial entity.

5. The evaluation method according to claim 4, wherein the plurality of data further includes one or more of an energy saving amount, a carbon reduction amount, a net income, a technical maturity, and a technical applicability, wherein:
the energy saving amount represents a difference between a consumption of a plurality of types of energy in a case where the industrial entity does not use the low-carbon technology in a third time period and the consumption of a plurality of types of energy in the case where the industrial entity uses the low-carbon technology in the second time period, wherein a duration of the third time period is the same as that of the second time period;
the carbon reduction amount represents a difference between a carbon emission in the case where the industrial entity does not use the low-carbon technology in the third time period and a carbon emission in the case where the industrial entity uses the low-carbon technology in the second time period;
the net income represents a difference between an income in the case where the industrial entity uses the low-carbon technology and the investment cost;
the technical maturity represents a practical degree of industrialization of the low-carbon technology; and
the technical applicability represents a feasibility of the low-carbon technology in practical application and an effectiveness of the low-carbon technology in practical application.

6. The evaluation method according to claim 5, wherein:
the plurality of first-level indicators includes an energy environment indicator, a cost-effectiveness indicator and a technical feature indicator;
the energy environment indicator corresponds to the energy consumption intensity, the carbon emission intensity, the energy saving amount and the carbon reduction amount;
the cost-effectiveness indicator corresponds to investment cost and the net income; and
the technical feature indicator corresponds to the technical safety, the technical maturity and the technical applicability.

7. The evaluation method according to claim 1, wherein the second score is positively correlated with the first score, and positively correlated with the energy structure proportion.

8. The evaluation method according to claim 7, wherein the second score is a product of the first score and the energy structure proportion.

9. The evaluation method according to claim 2, wherein the third score is positively correlated with the second score, and positively correlated with the process energy consumption proportion.

10. The evaluation method according to claim 9, wherein the third score is a product of the second score and the process energy consumption.

11. A determination method of a low-carbon technology, comprising:
determining effects of a plurality of low-carbon technologies to be selected, by using the evaluation method of a low-carbon technology according to claim 1, taking each of the plurality of low-carbon technologies to be selected as the low-carbon technology respectively; and
selecting a low-carbon technology to be selected with a best effect from the plurality of low-carbon technologies to be selected as a target low-carbon technology used by the industrial entity.

12. An electronic device, comprising:
a memory; and
a processor coupled to the memory and, based on instructions stored in the memory, configured to:
determine a first score of the low-carbon technology according to an analytic hierarchy process;
determine a second score of the low-carbon technology according to the first score and an energy structure proportion of an industrial entity, wherein the energy structure proportion is a ratio of a consumption of a first type of energy of the industrial entity in a first time period to a consumption of a plurality of types of energy of the industrial entity in the first time period, and the first type is a type of energy saved by using the low-carbon technology; and
evaluate an effect of the industrial entity in using the low-carbon technology according to the second score.

13. The electronic device according to claim 12, wherein the processor is configured to:
determine a third score of the low-carbon technology according to the second score and a process energy consumption proportion of the industrial entity, wherein the process energy consumption proportion is a ratio of a consumption of energy consumed by a second type of process of the industrial entity in the first time period to a consumption of energy consumed by a plurality of types of processes of the industrial entity in the first time period, and the energy consumed by the second type of process includes the first type of energy; and
evaluate the effect of the industrial entity in using the low-carbon technology according to the third score.

14. The electronic device according to claim 12, wherein the processor is configured to:
analyze a plurality of data required by the analytic hierarchy process to establish an evaluation indicator system, wherein the evaluation indicator system includes a plurality of evaluation indicators including a plurality of first-level indicators and a plurality of second-level indicators, the plurality of second-level indicators is in one-to-one correspondence with the plurality of data, each first-level indicator corresponds to at least one second-level indicator, and each second-level indicator corresponds to only one first-level indicator;
calculate a weight of each evaluation indicator in the evaluation indicator system; and
determine the first score according to the weight of each evaluation indicator and a membership degree of the plurality of second-level indicators.

15. The electronic device according to claim 14, wherein the plurality of data includes one or more of an energy consumption intensity, a carbon emission intensity, an investment cost and a technical safety, wherein:
the energy consumption intensity represents a ratio of a consumption of a plurality of types of energy in a case where the industrial entity uses the low-carbon technology in the second time period to a total industrial output value of the industrial entity in the second time period;
the carbon emission intensity represents a ratio of a carbon emission in the case where the industrial entity uses the low-carbon technology in the second time period to the total industrial output value;
the investment cost represents a cost of using the low-carbon technology by the industrial entity; and
the technical safety represents a safety of using the low-carbon technology by the industrial entity.

16. The electronic device according to claim 15, wherein the plurality of data further includes one or more of an energy saving amount, a carbon reduction amount, a net income, a technical maturity, and a technical applicability, wherein:
the energy saving amount represents a difference between a consumption of a plurality of types of energy in a case where the industrial entity does not use the low-carbon technology in a third time period and the consumption of a plurality of types of energy in the case where the industrial entity uses the low-carbon technology in the second time period, wherein a duration of the third time period is the same as that of the second time period;
the carbon reduction amount represents a difference between a carbon emission in the case where the industrial entity does not use the low-carbon technology in the third time period and a carbon emission in the case where the industrial entity uses the low-carbon technology in the second time period;
the net income represents a difference between an income in the case where the industrial entity uses the low-carbon technology and the investment cost;
the technical maturity represents a practical degree of industrialization of the low-carbon technology; and
the technical applicability represents a feasibility of the low-carbon technology in practical application and an effectiveness of the low-carbon technology in practical application.

17. The electronic device according to claim 16, wherein:
the plurality of first-level indicators includes an energy environment indicator, a cost-effectiveness indicator and a technical feature indicator;
the energy environment indicator corresponds to the energy consumption intensity, the carbon emission intensity, the energy saving amount and the carbon reduction amount;
the cost-effectiveness indicator corresponds to investment cost and the net income; and
the technical feature indicator corresponds to the technical safety, the technical maturity and the technical applicability.

18. The electronic device according to claim 13, wherein the second score is positively correlated with the first score, and positively correlated with the energy structure proportion; and/or
the third score is positively correlated with the second score, and positively correlated with the process energy consumption proportion.

19. The electronic device according to claim 12, wherein the processor is further configured to:
determine effects of a plurality of low-carbon technologies to be selected, by taking each of the plurality of low-carbon technologies to be selected as the low-carbon technology respectively; and
select a low-carbon technology to be selected with a best effect from the plurality of low-carbon technologies to be selected as a target low-carbon technology used by the industrial entity.

20. A non-transitory computer-readable storage medium, comprising a computer program which, when executed by a processor, implements the evaluation method according to claim 1.
